(19) United States
(12) Patent Application Publication
(10) Pub. No.: US 2002/0067839 A1
(43) Pub. Date: Jun. 6, 2002

(54) The wireless voice activated and recogintion car system

(76) Inventor: Timothy K. Heinrich, Moorpark, CA (US)

Correspondence Address: TIMOTHY K. HEINRICH, 4295 HITCH BLVD, MOORPARK, CA, 93021, US

(21) Appl. No.: 09/733,555

(22) Filed: Dec. 4, 2000

(51) Int. Cl. H04R 3/00; G10K 11/00; G10L 11/00

(52) U.S. Cl. 381/110; 704/275; 367/198

(57) ABSTRACT

With wireless voice activation and recognition car system you're able to control all units and electronic devices in a car on command like the temperature, phone, radio, doors, windows, seat belts, all lights, DVD, screens, speakers, CD audio, CD-ROM, engine, cruise control, speed, and etc. Using the Radio/CD-Telephone System that will be built for this purpose will be able to connect with the 3-lens web cam, a graphical user interface remote screen, an intercom, a 6 CD-changer, a LCD screen with multiple personality, lap top, phone, and a wireless microphone all connected together. Now with the ability of talking through the wireless microphone and listening through the radio speakers for the phone, CD audio, DVD, CD-ROM.

### CROSS REFERENCES

### United States Patents

U.S. Pat. No. 6,130,625 on Oct. 10, 2000 Harvey; Michael Lee; application Ser. No. 788,298 Class 340/825.72 filed on Jan. 24, 1997

U.S. Pat. No. 6,138,100 on Oct. 24, 2000 Dutton, Dawn L.; application Ser. No. 059,912 Class 704/275 filed on Apr. 14, 1998

U.S. Pat. No. 6,151,572 on Nov. 21, 2000 Cheng; Yan-Ming; application Ser. No. 67,779 Class 704/235 filed on Apr. 27, 1998

U.S. Pat. No. D404,736 on Jan. 26, 1999 Alvarez; Jason Joel; application Ser. No. 082,569 Class d14/229 filed on Jan. 26, 1998

U.S. Pat. No. 6,067,278 on May 23, 2000 Owens; Kenneth R.; application Ser. No. 055,628 Class 369/7 filed on Apr. 6, 1998

U.S. Pat. No. 5,884,265 on Mar. 16, 1998 Squitteri; Paul Anthony: application Ser. No. 826,459 Class#704/275 filed Mar. 27, 1997

U.S. Pat. No. 6,009,383 on Dec. 28, 1999 Mony; George; application Ser. No. 961,141 Class 704/200 filed on Oct. 30, 1997

### Foreign Patents

Patent #5896554 on Apr. 20, 1999 Itoh; Yoshikazu; Application #831858 Class 455/2 filed on Apr. 2, 1997

Patent #6124804 on Sep. 26, 2000 Kitao, Mitsuru; Application #554516 Class #340/825.69 filed on Nov. 7, 1995

Patent #6097928 on Aug. 1, 2000 Jean; Bong Shin; Application#948460 Class#455/8 filed on Oct. 10, 1997

Patent #6134220 on Oct. 17, 2000 Le Strat; Evelyn; Application#727429 Class#370/252 filed on Oct. 11, 1996

Patent #5950117 on Sep. 7, 1999 Zorer; Jean-Louis; Application#631384 Class 455/186.1 filed on Apr. 12, 1996

Patent #D400531 on Nov. 3, 1998 Kokkinis; Serge; Application#066951 Class#D14/168 filed on Feb. 27, 1997

### BACKGROUND OF THE INVENTION

1. Field of Invention

A wireless mobile transmitter FIG. 4 to send a predetermined frequency to the primary station FIG. 1 which has a processing section, modulating section, transmitting section, receiving section, demodulating section, transmission switching system, and receiving end switching section.

When signals received from multi-path transmitters from a predetermined channel connecting to the same primary station which provides a coding mode, each mode corresponding to a predetermined source code and a predetermined channel code for transmission of a wanted signal for each transmission direction.

Between the primary station and receiving station two separate of transmission quality are carried out for each transmission directions one coding mode is selected in accordance with the corresponding transmission.

A number of control channels and unit groups correspond with the primary station which executes by one radio unit among a number of other unit groups through a predetermined control channel.

Executing the communication by the primary station through one or more control channels which can be operated at once or if one has a fault.

Each control channel has a separate line connecting with the different control units connecting to the primary station in which the receiving station with a predetermined signal which will activate that unit.

Having more than one control channel connected to the primary station can control at a predetermined frequency unlimited of units inside a car including radio, CD, telephone, windows, locks, lights, temperature, doors, seat belts, power steering, cruise control, engine, web cam, DVD, CD-ROM, CD-Changer from a predetermined distance.

The invention relates to a remote controller, a web camera, CD-changer, a car radio and voice activation working together as one unit.

Today remote controls are used for almost any electronic gadget inside a house including a television, a stereo, and a VCR.

The invention of the Universal Remote Control by Harvey, Michael Lee who created one remote control to be able to control all of the electronic units inside a house.

Now (VAC) Voice Activated Connection system has leaped forward in a technology age where we can now dial your mom's phone number by saying “Call Mom” where the words are stored in a dialog box, which are than referred when a person requests a command.

A graphical user interface is a type of display format that enables a user to choose commands, start programs, and see lists of files and other option by pointing to pictorial representations and lists of menu items on a computer display screen.

Cell phones have come along way in today's technology era. We can now dial phone numbers, go on the web and even connect a head phone to speak into the phone with.

In recent years the music industry have been building smaller and better-looking CD/Tape players, but now we need to think of being able to play DVD and CD-ROM in the same CD player.

2. Description of Prior Art

With technology expanding we need to equip our cars with the right tools so they can be compatible in today's society.

The radio system as been around for a long time now, but we still can only play CD's or tapes inside the system.

The cell phones are getting so small you can't even see them any more, but with all the technology we have we still have to hold our cell phones to talk with.

With the headphones being made for cell phones; studies are trying to prove that radiation is being sent right through the headsets to our brains.

Most phones don't have voice activation and the capability of voice recognition.

CD-Changers is great, because now you have a greater wide of choices to choose from.

The problem though is what if you have a DVD player or a CD-ROM player shouldn't you has a CD-Changer that could hold all three.

The Internet is great on cell phones and the new Palm systems, but the screens are so small and how do you type messages.

What if a person is late for a meeting and doesn't need to talk to his business partners, but needs to show them graphs and charts.

Is there any way from sitting inside a car; a person could give a presentation.

On a cold windy night in the pitch dark and having bad vision it must get pretty scary driving at night.

### SUMMARY OF THE INVENTION

It is, therefore, an object of the invention to provide the Wireless Voice Activation and Recognition Car System including a wireless microphone, which is transmitted, to the Radio/CD-Telephone System, which will then activate the predetermined unit or electronic device inside the car.

With several channel controllers a person can activate a unit by speaking into the voice activation transmitter FIG. 4; using a graphical user interface FIG. 2, which is mounted for monitoring the cars units and electronic devices on a touch screen in arms length, or manually grabbing the switch.

Now a person can connect the cell phone inside of the new Radio/CD-Telephone System by using an adapter cord and with voice activation and recognition to be able to turn the phone on, search for a number, dial it, and talk on the phone without even looking at it.

A lot of trouble is being able to listen on a cell phone with loud noises outside your car.

Well, since the phone is connected to the Radio/CD-Telephone System you can now listen on your phone through the car's radio speakers and talk through the wireless microphone.

It's a very dark cold night outside and you're all by yourself in a deserted parking lot; turn on your engine, lights, music and the heater from a predetermined distance away from the car so its nice and warm when you get inside.

While driving you'll be able to turn on any unit or electronic device connected to a control channel like your A/C, heater, lights, lock doors, by your voice.

On a long road trip don't worry with the 6 CD-Changer that can hold all three disc's; watch a DVD, play a CD-ROM game, or listen to your favorite CD audio.

Since the Radio/CD-Telephone System is connected to the speakers pop a DVD inside the system and listen to the movie through the radio speakers or click on headphones and listen to them on the wireless headphones.

While driving in the dark use the 3-lens web cam to see with the inferred and magnified lens on the screen at a predetermined distance of the road.

Use the 3-lens web cam to record video messages or have conversations with your friend, family, business partners so that they can view you from your car while talking.

With a hard drive installed with the Radio/CD-Telephone System copy or down load information onto or from the screen.

Be able to view a DVD movie, a video message, and the road at the same time on the new LCD split screen personality that can display different frames onto the same screen.

Change from listening to the CD audio to watching a DVD on the screens by voice recognition.

Use the graphical user interface to change unit or electronic options.

On screen will have option icons like mail, memo pad, car menu, internet, web cam, dialog box speaker options expenses, touch with finger or pen to move from screen to screen, or turn off the control channels like the intercom, graphical interface, and wireless microphone.

### BRIEF DESCRIPTION OF THE SEVERAL VIEWS OF THE DRAWING

FIG. 1. Shows the diagram of the Radio/CD-Telephone System

FIG. 2. A User Graphical Interface diagram

FIG. 3. A diagram of the 3-lens Web Camera

FIG. 4. Shows the diagram of the wireless microphone transmitter/Intercom

FIG. 5. A diagram of the LCD screen with the split personality

FIG. 6. Shows the diagram of the new CD-changer

### DETAILED DESCRIPTION OF THE INVENTION

The Wireless Voice Activated Car System will retransform the automobile industry into the twenty first centuries. Imagine a car that can be controlled by a single voice command. Today cars are equipped with CD/Tape players, a CD-Changer, power windows, locks, etc. and can turn a car engine with a button.

The problem with this is that we are at the point where are advances in today's technology era are just to sophisticated for an average automobile. We need to build a car with the capability of putting today's electronic devices inside the car.

Cell phones, which are very popular today, still have to hold the phone, and with headsets that studies have been trying to prove that the headphones direct the radiation directly into the brain.

So now connecting the phone with an adapter to the inside of the Radio/CD-Telephone System we can program the phone for voice activation and recognition.

Be able to dial phone numbers, look up phone numbers, switch from line 1 to line 2, hold, redial, answer the phone all with voice recognition.

The computer connected to the Radio/CD-Telephone System will be able to receive the predetermined channel control signal, process the transmitted signal, decode and search for predetermined unit or electronic device, and transmit signal for activating device.

Listening in a crowed commute can be very hard, but now with the Radio/CD-Telephone System be able to listen to conversations over the radio speakers and talk through the wireless microphone that can be put anywhere inside a car.

Having the ability to turn on any unit or electronic device with a voice command while driving like changing radio to CD, calling on the phone, or changing the temperature with the voice activation system.

By using voice recognition only the programmer's voice can operate units and electronic devices using the voice activation, but passengers can use the intercom which operates as a walkie-talkie based solely on the primary station and the single channel control.

Passengers also have the option of using the graphical user interface by touching with their fingers or with a pen that will move them from screen to screen through option controls.

Using the screen for viewing many options pictured on icons like mail, memo pad, car menu, internet, expenses, calendar, car options, web camera, speaker options, phone, address book, dialog box.

Check any e-mail, voice mail, or video messages by touching the icon mail.

Use the memo pad with a pen that can write onto the screen.

Use the car menu to change any unit or electronic device inside the car like windows, doors, lights, temperature, safety belts, radio, phone, CD-changer; go on the internet and click around by using the pen or finger.

The graphical user interface doesn't only act as a remote control for all of the units and electronic devices, but also as a viewing option for the computer icons.

Look on budget details with the expense icon or see if you're free today with the calendar and mark dates or memos on screen with pen.

Use car options for speakers, volume, bass, tremble, fade, click on the web camera to choose the video messages or viewing for the road; look up an address with the address book, or forget what a command is use the dialog box to look it up.

Using the new 3-lens web camera be able to be seen from your car so you can give video messages, a business meeting, or even to use a 3-lens web camera to view at night with the inferred screen.

Now you can face the camera that's placed on the dashboard towards you to have a video conversation or away from you to see the road.

By switching the lens you can be viewed with the normal standard lens, use the inferred lens to view at night, or use the magnified lens to see up to a predetermined distance of the road.

Be able to record video with the 3-lens web cam for up to a predetermined time on a blank CD by placing it in the radio system and hitting record.

The web camera will be wired through the computer system so the wires won't be on top of the dashboard.

With voice activation and recognition start your car; turn on your lights, heater, and radio all from a predetermined distance away from your car with the wire less microphone.

Lock your keys inside car use the wire less microphone to open doors.

Use the Voice recognition to change CD's from the CD-changer in the back and use the viewing screen to see the options.

Having a disk drive you can now insert a disk to save any information on your screen that you need to type up later.

By using a pad connected to the car and a pen write notes on the memo screen and save them for later on the disk.

Pop in the navigational disk inside for activation.

Need to use a laptop don't worry, because using the adapter hole connect the laptop and type away?

### DESCRIPTION OF THE PREFERRED EMBODIMENT

The invention described herein provides a graphical user interface, wireless microphone to voice activate the Radio/CD-Telephone System, a 3-lens Web Cam, CD-Changer, and the LCD screen with split personality.

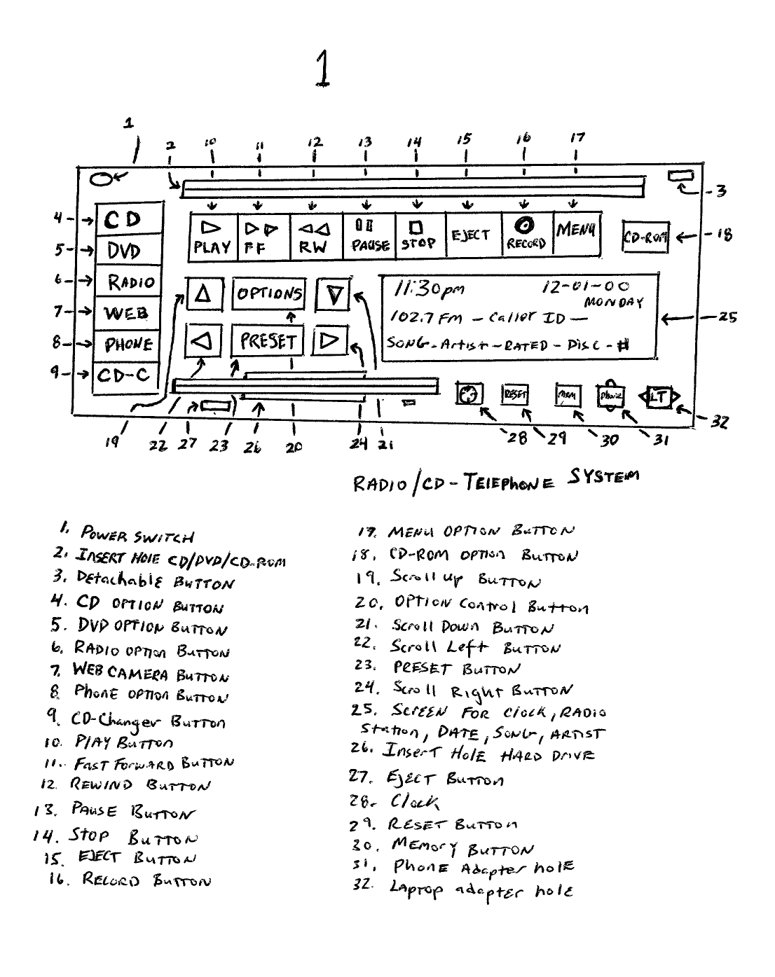

Referring to FIG. 1, the Radio/CD-Telephone system includes a small interface screen 25, which will display the clock 28, preset options for radio 23 and using the buttons 19-24 to scroll left, right, up, or down.

The button 2 is the opening insert for the DVD, CD, and CD-ROM player. Using the buttons 10-16 you have the options of Play, FF, RW, Pause, Stop, Eject, and record. To play the radio 5 you can click on the button 5 or use voice command. Hitting the Web 7 button will allow you to use the 3-lens Web Cam.

Pushing the Phone 8 will allow you to use the phone. The CD-C 9 button is to use the CD-Changer in the back of the car. Need to save any information insert a disk in the hard drive 26 and take it be hitting the eject button 27. To turn the radio system on or off hit the switch 1.

To hook up a lap top with the radio system plug it in the hole 31 and to adapt the phone use hole 32. To save preset radio stations use the memory button 30 or to cancel and reset use the 27 button.

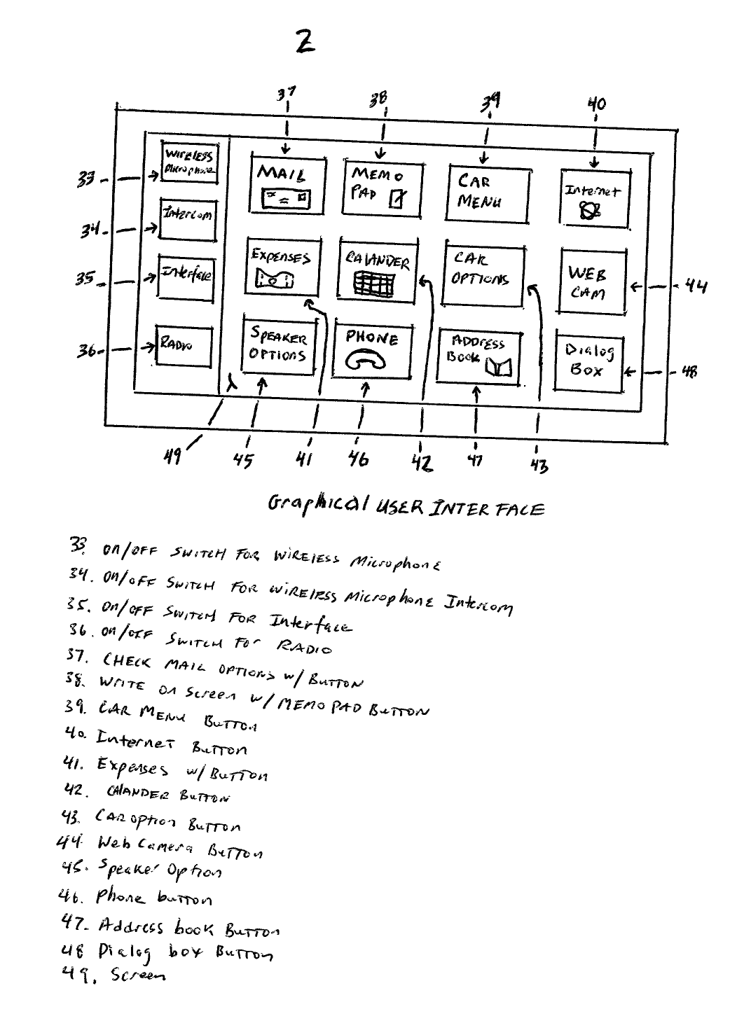

When you hit Options 20 or Menu 17 you can view your screen options on the FIG. 2 the graphical user interface. Touching the screen with a finger or pen will send a transmitted signal predetermined to a receiver in the predetermined unit to activate on command.

In FIG. 2 referring to the buttons Car Menu 39 and Car Options 43 are the same data screen, but with different lines connecting to the screen incase if one goes down you still can use the other control channel.

The small Icon's displayed on the graphical user interface can be touched and will then move to the next screen clearing everything on the present screen to just that icon option.

The Mail 37, Memo Pad 38, Internet 40, Expenses 41, Date Book 42, Web Cam 44, Speakers 45, Phone 46, Address Book 47, Radio 48, all of linking screens that connect. Moving back or forward from screen to screen by touching with a pen or your fingers.

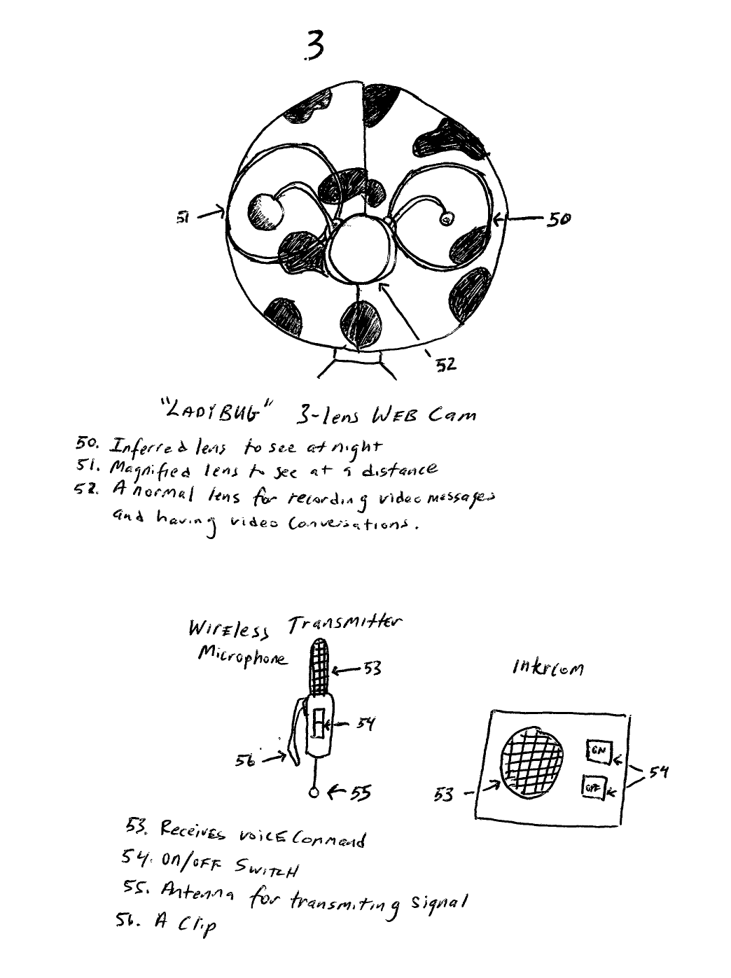

Safety locks are needed incase your children or passengers are abusing the wireless microphone FIG. 4 or the Intercom FIG. 4, the graphical user interface FIG. 2, or the Radio/CD-Telephone System.

So the buttons 33, 34, 35, 36 are on and off switch that can be pushed which will stop the signals from being connected from the channel controller to the transmitter.

With voice recognition only you can operate all units and electronic devices.

With a password it could activate the wireless microphone and it will protect users from taking the wireless microphone and using it.

The Graphical User Interface acts as a second control channel which receives the signal from a touch and will use the predetermined code channel to send a transmission to the predetermined unit connected to the car's system.

Referring to FIG. 3 the 3-lens web cam, which can be connected to the Radio/CD-Telephone System to be able to view the road with inferred, and a magnified vision. Using the inferred lens 50 to see at night. Put the magnified lens 51 to see at a predetermine distance ahead for any dangerous objects. Installed in the web cam is the lens 52, which is the standard view for using video messages, or recordings.

In FIG. 3 the web cam is designed as a “Lady Bug”.

Using different shapes of animals, people, and buildings, and putting the web cam inside the object for decoration you can choose from many variations of the decorated cam and just install it by plugging it in to the wires on top of the dash board.

By clicking on the buttons 44 and 7 you will be connected with the option screen for Web Cam.

In here you can choose to record, create, or send video messages, and have the option to view the road with the 3-lens cam.

In FIG. 4 the Wireless microphone is a receiver and transmitter. Referring to 53 on FIG. 4 where someone will speak into the microphone, it will receive the information and then transmit a signal to the Radio/CD-Telephone System FIG. 1 using the antenna 55.

When not using the Wireless microphone deactivate by turning the off switch on 54.

When you get to use the wireless microphone switch it back to on

Using the wireless microphone FIG. 4 to transmit a predetermined signal over the receiving section in the Radio/CD-Telephone System FIG. 1 where it will be processed, from the dialog box, and then determine what channel code a transmission will be sent to the predetermined unit to activate system.

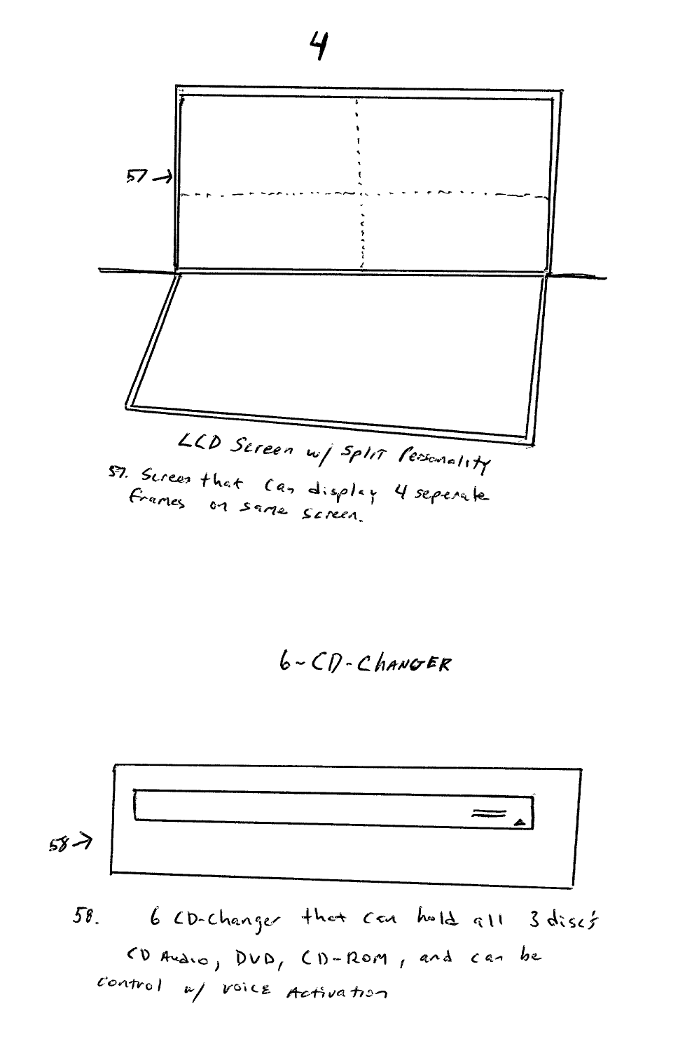

When the transmission connects with the receiving unit like a LCD Screen FIG. 5 it will receive the signal and determine what command was sent through the dialog box. Was it to turn the screen off or on. With voice activation switch the multiple LCD screens and choose which screen to play the DVD and, CD-ROM.

Say “screen 1 play DVD and screen 2 play CD-ROM” and then use the speaker option to choose which speaker plays the DVD volume.

The LCD screen will pop up from the dash board above the Graphical user interface so wiring can be connected with both the Radio/CD-Telephone System FIG. 1, wireless microphone line FIG. 4, and the Graphical user interface line FIG. 2 so any channel control will be able to activate the LCD screen.

With only one LCD screen in a car use the split screen personality FIG. 5 which means that the LCD can be split into different frames allowing at the same time to view a DVD, a video message, or the road.

Click the button Menu options 17 or Menu option 39 to change the view on the screen.

Many buttons are the same as other buttons, but have different numbers for a main reason.

If one control channel goes down then that control line won't work to activate any units or electronic devices.

If this ever did happen having more than 1 channel controller like the Wireless Microphone FIG. 4, Graphical User Interface FIG. 2, Radio/CD-Telephone System FIG. 1, or the Intercom FIG. 4 all of their own channel.

So if the Menu options button 17 goes down, you could still use Menu option 39 to select screen options.

When using a CD-Changer FIG. 6 you must connect it to the different control channels so you can change the CD-Changer with any remote controller.

This CD-Changer will be able to hold up to 6 different CD's, DVD's, or CD-ROM's.

That way you can scan the CD-Changer and play a CD Audio, CD-ROM, and DVD in the same car system.

By using the same technology as the Sony Play Station 2 where you're able to play any of the three, but now you can just hold more CD's.

What is claimed is:

1. What I claim is using an intercom and having its own separate control channel to the primary station that will be installed inside the car.
The method of claim 1 is to use an intercom inside a car that can be activated with an on and off switch for passengers could use without voice recognition.
The intercom has access to all of the units and electronic devices connected to the control channel, but on the Radio/CD-Telephone System there is a safety switch that will allow the driver to shut off the communication between the intercom and primary station.
The intercom has access to all of the units and electronic devices connected to the control channel, but on the Radio/CD-Telephone System there is a safety switch that will allow the driver to shut off the communication between the intercom and primary station.

2. I claim that using a 3-lens web cam with decoration can be connected to the Radio/CD-Telephone System.
Referring to claim 2 of using one lens with a normal view for recording and viewing video messages on the screen, lens two with an inferred lens for viewing at night, and lens three a magnified lens for seeing at a predetermined distance of the road.
Building web cams with different shapes and sizes of animals, people, and nature objects can be decorated for the dashboard and be placed by plugging the wires through the dashboard to the web cam.

3. I claim using a 6 CD-Changer connected with all control channels to be able to be voice activated.
Referring to claim 3 have a CD changer capable of holding all three disc's CD audio, DVD, and CD-ROM.
Using a control channel to activate the CD changer view the disc's inside on the display options on screen to see which disc is which.

4. I claim a User Graphical Interface connecting with the Radio/CD-Telephone which will monitor the options of a unit or electronic device inside the car.
The method of claim 4 is to use a graphic display for selecting one of the plurality of display data based on the data indicating the operation mode included in the response signal and displaying one of the graphic characters based on the selected display data.
A signal generator having stored there in a device code which specifically identifies the type of the electronic device for generating a response signal containing the device code.
The system of claim 4 will allow a person to touch or use a pen to choose an icon displayed on the user interface which will move them to the next screen of options where the person could activate the unit or electronic device.
Use the graphical user interface with a pen to write on the screen for notes or getting to point A to point B.

5. I claim a wireless mobile transmitter will transmit at a predetermined distance a signal that will be received by the primary station, which is the Radio/CD-Telephone System.
Referring to claim 5 the primary station receives the signal from a voice command through the wireless mobile transmitter where it then processes the signal, searches through codes, and receives additional information on where the predetermined signal should be transmitted to the predetermined unit to activate.
The wireless microphone remote controller according to claim 5, triggers a signal transmitter for a transmitting a trigger signal for causing the Radio/CD-Telephone System to transmit a response signal; generating control signals based on the selected control codes, and transmitting the generated control signals to the car unit in order to activate the corresponding operational functions in the electronic device.
Be able to activate any of the units or electronic devices inside a car with voice activation and recognition like windows, doors, temperature, seat belts, radio, CD, DVD, screens, CD-changer, phone, and etc.

6. I claim that the Radio/CD-Telephone System which has a memory section for storing plurality of control codes retrieved from the response signal, a data generator for selectively retrieving a control code from among the dialog box of control codes having been stored in the memory and voice activation with recognition.
Referring to claim 6 each unit and electronic device has a predetermined control channel and a control code that receives the response signal from the multi path control channels.
A signal transmitter for transmitting a trigger signal for causing the selected electronic device to transmit a response signal containing the device code for activation.
The Radio/CD-Telephone System can play a CD Audio, DVD, or CD-ROM inside the radio system and be controlled by the multi path control channels including the voice activation, graphical user interface, intercom and can be heard through the car's speakers.
Radio/CD-Telephone System has a hard drive to insert disks for saving or down loading data.
The Radio/CD-Telephone System had the ability to adapt a cell phone and a laptop using the head set hole on a cell phone into an adapter in the Radio/CD-Telephone System.
Connected with the speakers and screens be able to choose which speaker plays music, the DVD volume, CD-ROM music, and which screens can have the split personality trait of able to play more than one frame on screen.
The method of claim 6 is to play on one screen a DVD movie and also have the half of the screen showing a video conversation, and with voice activation and recognition choose the screen they should be played on by command.
